(19) United States
(12) Patent Application Publication
(10) Pub. No.: US 2002/0089946 A1
(43) Pub. Date: Jul. 11, 2002

(54) System and method for providing a timing reference for data transmissions in a satellite-based communications network

(76) Inventor: Jonathon M. Hutchings, Encinitas, CA (US)

Correspondence Address: Hughes Electronics Corporation, Patent Docket Administration, P.O. Box 956, Bldg 1, Mail Stop A109, EI Segundo, CA, 90245-0956, US

(21) Appl. No.: 09/755,920

(22) Filed: Jan. 5, 2001

(51) Int. Cl. H04Q 7/00

(52) U.S. Cl. 370/324; 370/278

(57) ABSTRACT

A system and method for providing a timing reference on which data transmission between a network hub and a user terminal in a satellite-based communications network are based. The system and method employs an outroute hub, adapted to transmit a timing signal to a satellite in the network for receipt by the network hub and the user terminal. The system and method further employ a data transmission timing apparatus, disposed at the network hub and adapted to establish, based on the timing signal, the timing reference on which data transmission from the user terminal to the network hub is based. The timing signal can be a stream of data frames, such as Reed-Solomon frames, that are grouped into respective groups of data frames, and are numbered such that the data transmission timing apparatus establishes the timing reference based on the numbers assigned to the data frames.

### BACKGROUND OF THE INVENTION

1. Field of the Invention

The present invention relates to a system and method for providing a timing reference on which data transmission in a satellite-based communications network are based. More particularly, the present invention relates to a system and method for providing an arbitrary and periodically structured satellite transmission which acts as a timing reference for data transmission in a time-division multiple access (TDMA) satellite-based communications network.

2. Description of the Related Art

A satellite-based communications network, such as a telephony network or data transmission network, typically employs at least one base station, one or more satellites, such as low-earth orbit (LEO) satellites or geosynchronous earth-orbit (GEO) satellites, and a plurality of user terminals, such as remote telephones or data terminals. In a typical network, data is transmitted between the user terminals and base stations in the form of packets or frames, which can be time-division multiple access (TDMA) frames or code-division multiple access (CDMA) frames, as can be appreciated by one skilled in the art.

In a TDMA based system, each frame is segregated into a plurality of slots. To access the network, a user terminal transmits an access request to its respective base station via one or more of the satellites. If the base station determines that a sufficient number of slots are available to support the rate of data transmission requested by the user terminal, the base station will transmit an access grant to the user terminal assigning the slots to the user terminal. The user terminal can then transmit data, such as telephony or other data, in the assigned slots to one of more of the user terminals.

As can be appreciated by one skilled in the art, a user terminal must transmit its data at the appropriate times so that the data is received by the base station in the appropriate time slot or slots. If the base station should receive an inroute burst from a user terminal at a particular instant in time (i.e., within a particular data slot), the time at which the user terminal must start its transmission must take into account the propagation delay that elapses for the data to travel from the user terminal to the base station via the satellite or satellites. If the transmission time for the user terminal is not properly synchronized, the transmitted data may not be received at the base station during the appropriate time slot. The transmitted data can thus collide with other data being transmitted to the base station from other user terminals, which can result in lost data.

A need therefore exists for a system and method for accurately and effectively establishing a timing reference in accordance with which data transmissions in a satellite-based communications network are to occur.

### SUMMARY OF THE INVENTION

An object of the present invention is to provide a system and method for establishing a timing reference on which data transmission in a satellite-based communications network are based.

Another object of the invention is to provide a system and method that uses an arbitrary and periodically structured satellite transmission as a timing reference for data transmission in a time-division multiple access (TDMA) satellite-based communications network.

These and other objects are substantially achieved by providing system and method for providing a timing reference on which data transmission between a network hub and a user terminal in a satellite-based communications network are based. The system and method employ an outroute hub, adapted to transmit a timing signal to a satellite in the network for receipt by the network hub and the user terminal. The system and method further employ a data transmission timing apparatus, disposed at the network hub and adapted to establish, based on the timing signal, the timing reference on which data transmission from the user terminal to the network hub is based. The timing signal can be a stream of data frames, such as Reed-Solomon frames, that are grouped into respective groups of data frames, and are numbered such that the data transmission timing apparatus establishes the timing reference based on the numbers assigned to the data frames.

The above objects can further substantially be achieved by providing an apparatus and method, adapted for use with a satellite-based communications network comprising at least one satellite, at least one network hub and a plurality of user terminals, for providing a timing reference on which data transmissions between the at least one network hub and the plurality of user terminals are based. The method and apparatus employ a transmitter, which is adapted to transmit an uplink signal to a satellite in the network for receipt by the at least one network bub, the plurality of user terminals and the apparatus. The method and apparatus further employ a receiver, which is adapted to receive an echo signal based on the uplink signal transmitted to the satellite, and a timing device, which is adapted to establish the timing reference based on a time at which the receiver receives the echo signal in relation to a time at which the transmitter transmitted the uplink signal. The timing device can generate the timing reference as a stream of data frames, such as Reed-Solomon frames.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a conceptual block diagram of a network according to an embodiment of the present invention;

FIG. 2 is a block diagram of an example of components of a satellite terminal employed in the network shown in FIG. 1;

FIG. 3 is a block diagram illustrating an example of components of an outroute hub employed in the network shown in FIG. 1; and

FIG. 4 is a block diagram illustrating an example of components of a network hub employed in the network shown in FIG. 1.

### DETAILED DESCRIPTION OF THE PREFERRED EMBODIMENTS

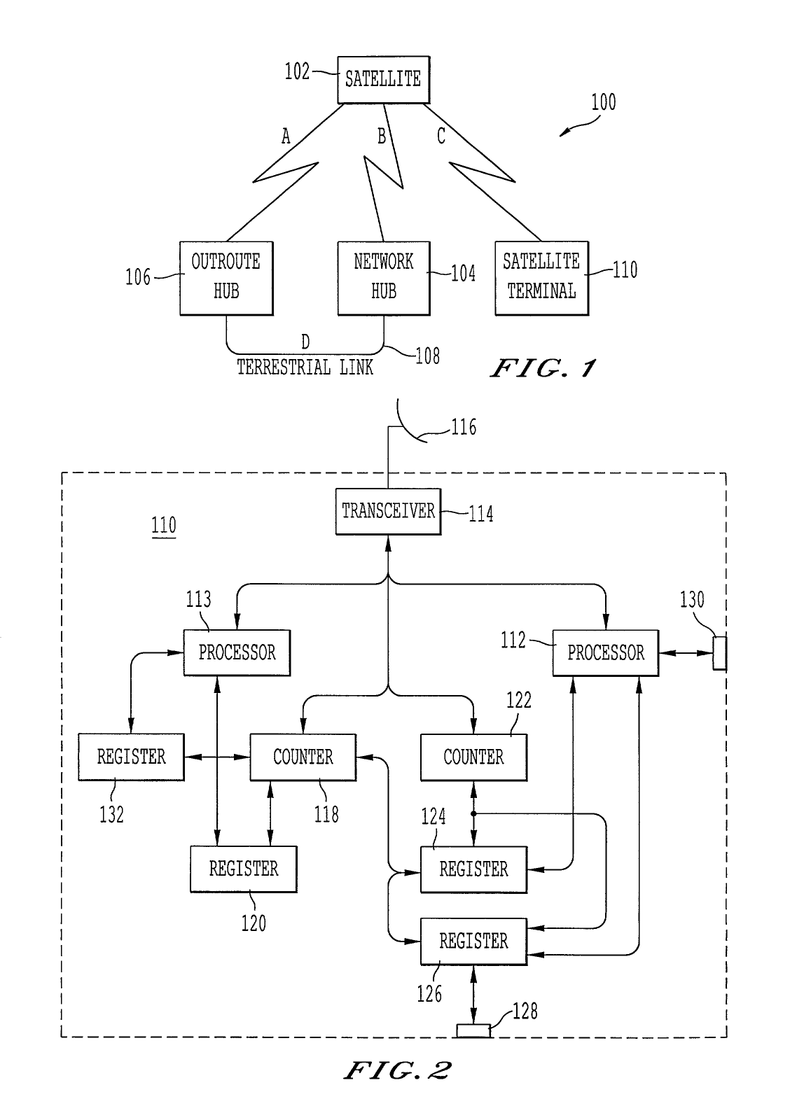

FIG. 1 is a block diagram illustrating components of a communications network 100 according to an embodiment of the present invention. As illustrated, the network 100 includes a satellite 102, such as a geosychronous earth orbit (GEO) satellite, a network hub 104, an outroute hub 106 coupled to the network hub 104 by, for example, a terrestrial link 108, and a plurality of satellite terminals 110, such as very small aperture terminals (VSATs). For simplicity, only one network hub 104 and only one terminal 110 are shown. However, the network 100 can support additional network hubs 104 which communication with respective terminals 110.

As can be appreciated from the following description, the configuration of the network hubs 104, outroute hub 106 and satellite terminals 110 allows multiple TDMA satellite networks to be hosted on a preexisting, unmodified satellite transmission, and supports standard TDMA inroutes on minimally modified network hub hardware and software. The configuration requires little or no modifications to the outroute transmission hardware of the outroute hub 106, minor modifications to the hardware of the network hub 104, and relatively simple hardware support in the satellite terminals 110. The components of the network 100 conceptually structure Reed-Solomon frames transmitted on the outroute of the outroute hub 106 into periodic superframes, and have each network hub 104 coordinate its inroute timing using the frames and superframes of the outroute transmission of the outroute hub 106 as a timing reference.

The transmission from the outroute hub 106 to the satellite 102 is used as a common timing reference across the network 100 as will now be explained. The outroute transmission originates at the outroute hub 106, is uplinked to the satellite 102, and is received by all network sites, that is, by the outroute hub 106, the network hub(s) 104 and the satellite terminal(s) 110.

In this example, the outroute transmission is a continuous stream of Reed-Solomon frames of a fixed size. The outroute hub 106 groups the frames into superframes of size N each by conceptually numbering the sequential frames 0 . . . N−1. To maintain a common frame numbering scheme across the network 100, the outroute hub 106 periodically places a frame numbering packet into the outroute data stream. Given the common numbering scheme, the local time at a given site in the network 100 is then defined as the whole and fractional ReedSolomon frame number currently being received at that site.

There are several competing factors influencing the selection of the number of ReedSolomon frames per outroute superframe. For example, the number should be large enough to avoid ambiguity in outroute timestamps, while being small enough to allow reasonable hardware counter sizes, and small enough to obtain satellite echo delay results at a reasonable rate. In this example, the number of frames is selected at each data rate such that there is an outroute superframe about once per second. As explained in more detail below, at the highest currently required outroute data rate, a 15 bit counter is sufficient to count the number of frames.

As explained in more detail below, the purpose of network timing is to maintain the correct burst timing on the inroutes of the network hubs 104 of the network 100. The burst timing of the inroutes of a network hub 104 is independent of the outroute timing of the outroute hub 106, since each are running on separate oscillators. That is, the outroute hub 106 is running on an oscillator local to itself, and the inroutes of a network hub 104 are running on an oscillator local to that network hub 104. The oscillators associated with the outroute hub 106 and network hub 104 are accurate enough so that periodic broadcasts by the network hub 104 of the proper outroute-to-inroute timing relationship allows the satellite terminals 110 associated with that network hub 104 to maintain proper inroute timing.

As can be appreciated by one skilled in the art, the network hub 104 must inform its associated satellite terminals 110 of the correct local time at which to begin its inroute transmissions. That is, referring to the diagram in FIG. 1, if the network hub 104 expects to receive an inroute burst from a satellite terminal 110 at network hub local time represented by the variable PES_HUB_INROUTE_TIME, the satellite terminal 110 must start its transmission at network hub local time minus the signal propagation time along paths B and C, which can be represented by the equation PES_HUB_INROUTE_TIME−(B+C). Again, this equation takes into account the time required for the transmission signal to travel from the satellite terminal 110 to the network hub 104. Also, at any moment, the local time at a satellite terminal 110, in terms of the local time at its respective network hub 104, can be represented by the equation PES_HUB_LOCAL_TIME−(C−B). By substituting into this equation the inroute transmission start time PES_HUB_INROUTE_TIME−(B+C) for PES_LOCAL_HUB_TIME, the equation becomes (PES_HUB_INROUTE_TIME−(B+C))−(C−B), which can be simplified to PES_HUB_INROUTE_TIME−2C, which represents the local time at which the satellite terminal 110 should begin the inroute transmission.

Based on its own local clock, the network hub 104 in this example declares an inroute frame boundary every 45 mlliseconds, and an inroute superframe every 8 inroute frames (every 360 milliseconds). To allow the satellite terminals 110 to maintain proper inroute timing, the hub broadcasts the value of PES_HUB_INROUTE_SUPERFRAME_TIME−2C to all satellite terminals 110, once per superframe. Consistent with the timing philosophies of standard networks of this type, the value of C that is used is normalized to the satellite terminal 110 at the furthest possible distance from the satellite 102. Satellite terminals 110 at smaller distances from the satellite 110 adjust the correct inroute superframe time upward according to their space timing offset. The value of the space timing offset for a given satellite terminal 110 will be the same as that used for a satellite terminal 110 in a standard network of this type, for example, the value from a standard latlong program as can be appreciated by one skilled in the art.

It should be noted that the value of C between a satellite terminal 110 and the satellite 102 varies due to satellite motion. As in a standard network of this type, a simplifying approximation can be made in which the motion of a satellite 100 is considered to be the same relative to all geographic locations in the network 100. In this case, the changes in the value of C due to satellite motion is assumed to be approximately the same as the changes in the value of A due to satellite motion, which are determined by measuring the outroute echo delay time at the outroute hub 106. The outroute hub 106 broadcasts the outroute echo delay time on the outroute to all network hubs 104, and all network hubs 104 will adjust the inroute superframe times that they broadcast to their respective satellite terminals 110.

Accordingly, in this embodiment of the present invention, inroute timing is no longer based on network hub outroute timing as in conventional networks. Rather, in the embodiment according to the present invention, network hub outroute timing is redefined to be a framework that represents the timing latency for inroute management traffic to travel from the network hub 104 to a respective satellite terminal 110 along the path D-A-C, as shown in FIG. 1. The timing of network hub outroute superframe boundaries are set so that a network hub outroute superframe packet, whose transmission is started by the software running at the network hub 104 immediately following an outroute superframe boundary, is guaranteed to arrive and be processed by all satellite terminals 110 associated with that network hub 104 one frame prior to the corresponding inroute superframe boundary at the satellite terminals 110. That requirement exists because the network hub outroute superframe packet contains information critical to the proper use of bandwidth in the subsequent inroute superfrarne.

For simplicity, this timing requirement is achieved by setting the network hub outroute superframe boundaries at the network hub 104 to precede the inroute superframe boundaries by a constant: max(D)+max(A)+2max(C)+max(B)+ONE_FRAME_TIME. In practice, max(A), max(B) and max(C) are known to a close approximation, so only max(D) is required to be a configuration parameter. The configured value for max(D) will include all the terrestrial processing delays within the network hub 104, the outroute hub 106, and the terrestrial link 108 that connects them.

The following describes an example of the hardware and software employed in the network shown in FIG. 1 to establish the network timing as discussed above. As will be appreciated from the following, the network control center (NCC2) of the network hub 104 and the satellite terminals 110 are the only components of the network 100 according to this embodiment that contain specialized hardware to support network timing.

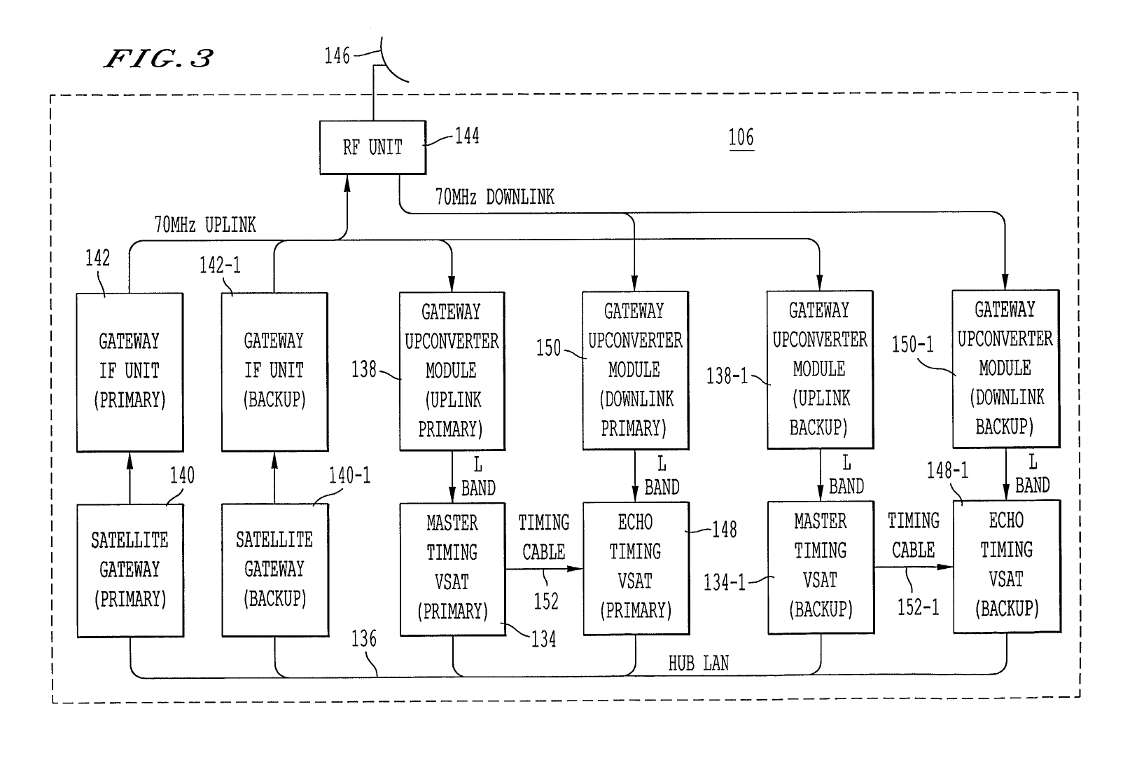

The hardware support in the satellite terminal 110 for the network timing is relatively simple, as will now be explained with reference to FIG. 2. Each satellite terminal 110 includes a VSAT protocol processor 112, such as an MIPS 4300 processor, and a second processor 113, such as a 3041 processor, for handling outroute receipt functions as described in more detail below. It is noted that in the following discussion, the term “software” refers to software running on processor 112.

As further shown in FIG. 2, each satellite terminal 110 includes a transceiver unit 114 for receiving and transmitting data to and from the satellite 102 via antenna 116. Each satellite terminal 110 further includes a Reed-Solomon frame counter 118 coupled to the transceiver unit 114. In this example, the frame counter 118 is a 15 bit binary down counter. When the counter 118 reaches zero, it will automatically be re-initialized to a software-selected value stored in a register 120.

Each satellite terminal 110 further includes a counter 122 for counting the time that has elapsed since the last received Reed-Solomon frame boundary. In this example, the counter 122 is a binary up counter with a granularity of 1 microsecond or better, with the counter 122 being reset to zero at the same time that the frame counter 118 is being incremented at the beginning of each Reed-Solomon frame. A register 124 captures the combined contents of the counters 118 and 122 the occurrence of a inroute frame boundary. The results of the capture are provided to the software running on the processor 112, and a processor interrupt will optionally be generated.

Each satellite terminal 110 further includes a register 126 for capturing the combined contents of the counters 118 and 122 on the occurrence of an external hardware signal. The hardware signal will enter the satellite terminal 110 through an auxiliary connector 128, and the external signal will be glitch filtered as can be appreciated by one skilled in the art. The results of the capture are provided to the software running on the processor 112, and a processor interrupt will optionally be generated. The processor 112 can generate a hardware output pulse on an auxiliary connector 130 at the time that the counter 118 is re-initialized or, in other words, on the Reed-Solomon frame boundary.

It is also noted that the software in this example has the ability to vary the length of an inroute frame with a granularity of 1 microsecond or better, and a length selection range of at least 44 to 46 milliseconds, with 45 milliseconds being the nominal transmit frame length The suggested implementation is a binary down counter representing the total frame length, loaded with a software selected value at the beginning of each inroute frame.

Each satellite terminal 110 further includes a register 132 to capture the contents of the counter 118 on the arrival of the first flag byte (7E hex) in the outroute data stream following a signal from software running on the processor 112. The captured result will be provided to software running on the processor 112. The implementation will assure that the captured value will unambiguously identify the Reed-Solomon frame that contains the last bit of the first flag byte that arrives after the signal from the software.

The following describes features of the outroute hub 106 involved in establishing the network timing as discussed above. In this example, the network timing implementation at the outroute hub 106 has two primary purposes, namely, structuring the Reed-Solomon frames of an outroute transmission into superframes, and measuring the echo delay to the satellite 102.

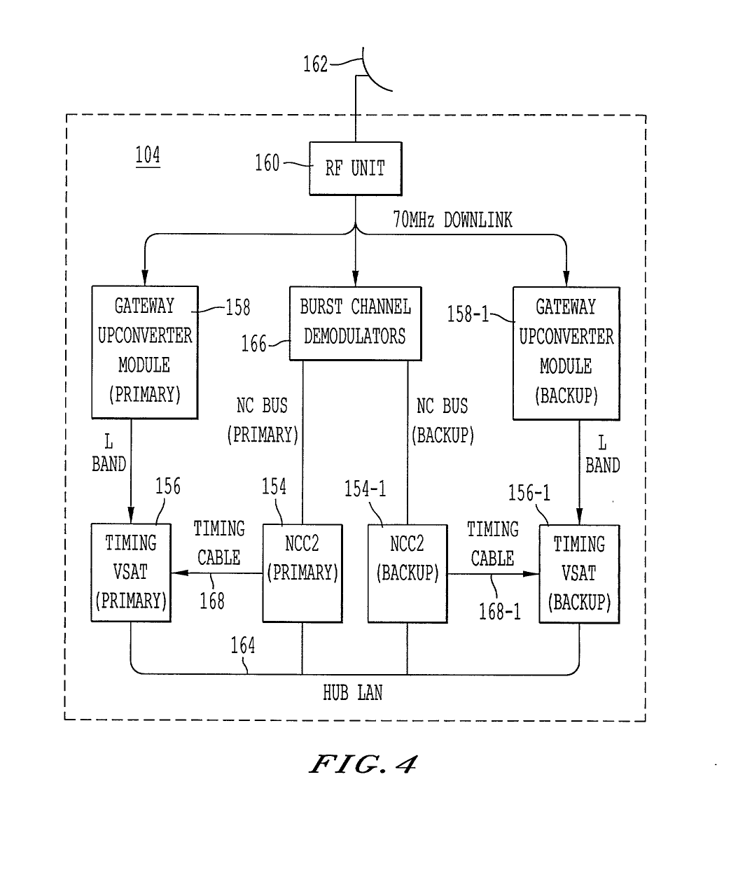

FIG. 3 shows an example of the components of outroute hub 106 that are involved in establishing the network timing. It is noted that there is full one-for-one redundancy of all components. The following description applies to the set of components (primary or backup) that is on-line or, in other words, active. The secondary components are identified with the same numbers as their corresponding primary components, with a “−1” suffix

The outroute hub 106 includes a master timing VSAT 134 that structures the Reed-Solomon frames of the outroute transmission are structured into superframes of the type and configuration as discussed above. The master timing VSAT 134 receives the outroute uplink through its L band interface, and conceptually forms the Reed-Solomon frames of the outroute into superframes of size N by numbering the Reed-Solomon frames of the received outroute from 0 . . . N−1. Specifically, the master timing VSAT 134 numbers the frames by using its local hardware Reed-Solomon frame counter (not shown). The N−1 . . . 0 sequence of the hardware frame counter is converted to the desired 0 . . . N−1 sequence by software running at, for example the master timing VSAT 134. The local frame numbers assigned by the master timing VSAT 134 are referred to as master frame numbers.

The master frame numbering of the outroute is communicated to the rest of the network 100 over the outroute A (see FIG. 1) using frame numbering packets. The master timing VSAT 134, in cooperation with the gateway upconverter module 138, periodically constructs a frame numbering packet and sends it over the hub LAN 136 to the satellite gateway 140 for placement in the outroute. The satellite gateway 140 forwards the frame numbering packet to the gateway IF unit 142, which in this example forwards the frame numbering packet to an RF unit 144 over a 70 MHz uplink. The RF unit 144 can transmit the frame numbering packet to the satellite 102 over outroute path A (see FIG. 1) via antenna 146.

As can be appreciated by one skilled in the art, the master timing VSAT 134 receives the frame numbering packets on the outroute uplink, and a coordination of hardware and software allows the master timing VSAT 134 to determine the master frame number in which the last bit of the closing flag of each frame numbering packet appears (the master frame number of the packet). Software running at, for example, the master timing VSAT 134 saves the master frame number of each frame numbering packet, and places that information into the next frame numbering packet. The transmission of a frame numbering packet does not have to be synchronized in any way with the Reed-Solomon frame boundaries of the outroute.

The hardware and software coordination needed to obtain the local frame number of a frame numbering packet will now be described. The frame numbering packets have a unique outroute media access control (MAC) destination address. When the software rubbibg at the master timing VSAT 134 receives the beginning of an outroute packet having that unique address, it will toggle a pin on a field programmable gate array (FPGA), not shown, which will signal the FPGA to store the Reed-Solomon frame number of the last bit of the next flag character that appears in the outroute bit stream That flag character will be the closing flag of the frame numbering packet. The FPGA will make the stored frame number available to be read by the software running at the processor 112 of the destination satellite terminal 110 (see FIG. 2). The value of the frame number does not have to be read immediately, because frame numbering packets are sent at a low rate (about once per second). The software at the processor 112 will read the stored value from the FPGA when it recognizes the presence of a frame numbering packet in the normal data stream from the software and an ASIC (not shown).

The network timing also requires than an accurate measurement be made of the echo delay from the outroute hub 106 to the satellite 102. The echo timing is obtained through a coordination of hardware and software on the master timing VSAT 134 and the echo timing VSAT 148.

In this example, the echo timing VSAT 148 acquires and maintains synchronization with the outroute downlink, which includes a gateway upconverter module 150. The echo timing VSAT 148 receives the frame numbering packets on the outroute, and uses the same hardware/software mechanism as the master timing VSAT 134 to determine the local frame number of each frame numbering packet. The echo timing VSAT 148 synchronizes with the master frame numbering by calculating the offset between the master frame number of the previous frame numbering packet (contained in the current frame numbering packet) and the local frame number of the previous frame numbering packet. That offset is referred to as the local frame number offset. The local frame number offset will be checked for consistency on the reception of each frame numbering packet.

To measure the echo delay, the hardware of the master timing VSAT 134 outputs a pulse at the beginning of master frame 0 of the outroute uplink. The pulse is carried by a special timing cable 152 to the echo timing VSAT 148, which is receiving the outroute downlink. On the occurrence of the pulse, the hardware of the echo timing VSAT 148 takes a snapshot of the local frame counter and a representation of the fractional frame. Software running at the echo timing VSAT 148 combines this information with the local frame number offset, the number of frames per superframe, and the current data rate to calculate the echo delay. The echo timing VSAT 148 sends the echo delay information over the hub LAN 136 to the master timing VSAT 134. The master timing VSAT 134 places the echo delay information into the frame numbering packets for use by the network hubs 104.

It is noted that the primary and backup master timing VSATs 134 and 134-1 coordinate redundancy between themselves over the hub LAN 136 to determine which master/echo timing VSAT pair should be on line. This redundancy operates independently of satellite gateway redundancy.

The following describes features of the outroute hub 106 involved in establishing the network timing as discussed above.

The network timing implementation at a network hub 104 has one primary purpose, which is to inform the satellite terminals 110 associated with the network hub 104 of the correct inroute frame timing. FIG. 4 shows and example of the components of a network hub 104 that are involved in establishing network timing. It is noted that there is full one-for-one redundancy of all components. The following description applies to the set of components (primary or backup) that is on-line or, in other words, active. The secondary components are identified with the same numbers as their corresponding primary components, with a “−1” suffix.

The network hub 104 includes a network control center (NCC2) 154. As with a standard NCC2, the NCC2 154 uses a local oscillator for inroute timing. In this example, the NCC2 154 declares an inroute frame boundary every 45 milliseconds, and an inroute superframe boundary every 8 frames (360 milliseconds). Also, even though the NCC2 154 no longer generates a standard outroute, the NCC2 154 retains the concept of outroute timing, and, in this example, declares an outroute frame boundary every 45 milliseconds and an outroute superframe boundary every 8 frames (360 milliseconds). As discussed above with regard to FIG. 1, the outroute superframe boundaries are set to precede the corresponding inroute superframe boundaries by a fixed timing offset: max(D)+max(A)+2max(C)+max(B)+ONE_FRAMETIME.

To calculate the correct inroute timing for the satellite terminals 110, the NCC2 154 must obtain the current echo delay between the outroute hub 106 and the satellite 102, and the time of the occurrence of the inroute frame boundaries set by the NCC2 154 relative to the outroute. The NCC2 154 obtains the current outroute hub/satellite echo delay from the contents of the frame numbering packets sent by the outroute hub 106 over the outroute. That is, the network hub 104 includes a timing VSAT 156, a gateway upconverter module 158, an RF unit 160 and an antenna 162. The timing VSAT 162 receives the frame numbering packets via the antenna 162, the RF unit 160 and the gateway upconverter module 158. The timing VSAT 156 then sends the received frame numbering packets over a hub LAN 164 to the NCC2 154. The RF unit 160 also provides downlink burst channels to the NCC2 154 via burst channel demodulators 166.

The NCC2 154 obtains the time of the occurrence of its inroute frame boundaries relative to the outroute through a hardware and software coordination with the timing VSAT 156. The NCC2 154 then outputs a hardware timing pulse every outroute superframe boundary. The hardware pulse is carried over a special timing cable 168 to the timing VSAT 156. The timing VSAT 156 determines the time of the pulse relative to the outroute, using the same mechanisms as described for the echo timing VSAT 148 of the outroute hub 106 as described above (see FIG. 3).

The timing VSAT 156 then sends the pulse timing information to the NCC2 154 over the hub LAN 164. The NCC2 154 calculates the outroute time of the corresponding inroute superframe by adding the fixed outroute-to-inroute timing offset. The NCC2 154 and all the VSATs in the network, including the satellite terminals 110, know the network outroute symbol rate and encoding, and therefore, can perform any required conversions between units of time and units of Reed-Solomon frames.

As can be appreciated from the above description, the NCC2 154 sends the necessary inroute timing information to its associated satellite terminals 110 in a new type of packet, which can be referred to as an inroute timing packet. The NCC2 154 transmits an inroute timing packet at least once per inroute superframe, typically following receipt of the latest outroute pulse timing information from the timing VSAT 156. The timing VSATs 156 of the network hubs 104 are always operational and continuously passing information to their associated NCC2 154. The NCC2s 154 use existing mechanisms to decide whether NCC2 154 or 154-1 will be on line.

As can further be appreciated from the above, the NCC2 154 hardware support for network timing is trivial, and backward compatible with a standard NCC2. The TXRX2 in the NCC2 154 is modified to output a hardware pulse on its auxiliary connector at each TXRX2 outroute frame boundary. The output pulse is permanently enabled. The necessary signal traces already exist on the TXRX2, so only an FPGA program ROM change is required.

This following provides further details on the implementation of network timing in a satellite terminal 110. The network timing implementation in a satellite terminal 110 has one primary purpose, which is to maintain the correct inroute frame timing. To do this, the satellite terminal 110 first determines the local frame number offset using the same mechanism as described for the echo timing VSAT of the outroute hub 106. Next, the satellite terminal 110 checks the start time of each of its inroute frames against the outroute. The satellite terminal 110 determines the correct start time for each of its inroute frames by combining its local space timing offset with the inroute timing information periodically broadcast by the NCC2 154 from its associated network hub 104.

The satellite terminal 110 adjusts for any errors in its inroute frame timing by locally adjusting the length of each inroute frame. The inroute frame timing is based on a local oscillator, but the accuracy of the local oscillator is such that only small adjustments in the length of each frame are required to maintain proper inroute timing. Small adjustments are tolerated by the burst generation hardware because inroute bursts do not span inroute frame boundaries. That is, there is a gap between the end of the last possible burst the VSAT might send in one frame and the beginning of the first possible burst that the VSAT might send in the next frame.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A system for providing a timing reference on which data transmission between a network hub and a user terminal in a satellite-based communications network are based, said system comprising:
an outroute hub, adapted to transmit a timing signal to a satellite in said network for receipt by said network hub and said user terminal; and
a data transmission timing apparatus, disposed at said network hub and adapted to establish, based on said timing signal, said timing reference on which data transmission from said user terminal to said network hub is based.

2. A system as claimed in claim 1, wherein said outroute hub comprises:
a data frame transmitter, adapted to transmit a stream of data frames as said timing signal.

3. A system as claimed in claim 2, wherein:
said data frame transmitter transmits said stream of data frames as Reed-Solomon frames.

4. A system as claimed in claim 2, wherein:
said data frame transmitter is adapted to group respective pluralities of said data frames into respective groups of data frames.

5. A system as claimed in claim 2, wherein:
said data frame transmitter assigns numbers to said data frames.

6. A system as claimed in claim 5, wherein:
said data transmission timing apparatus establishes said timing reference based on said numbers assigned to said data frames.

7. A system as claimed in claim 5, wherein:
said data frame transmitter includes in said data frame stream at least one frame numbering data packet on which numbering of said data frames is based.

8. A system as claimed in claim 1, wherein:
said data transmission timing apparatus is adapted to determine, based on said timing reference, time instants at which data frames transmitted from said user terminal are to arrive at said network hub.

9. A method for providing a timing reference on which data transmission between a network hub and a user terminal in a satellite-based communications network are based, said method comprising the steps of:
transmitting a timing signal from a location other than said network hub to a satellite in said network for receipt by said network hub and said user terminal; and
establishing at said network hub, based on said timing signal, said timing reference on which data transmission from said user terminal to said network hub is based.

10. A method as claimed in claim 9, wherein:
said transmitting step transmits a stream of data frames as said timing signal.

11. A method as claimed in claim 10, wherein:
said transmitting step transmits said stream of data frames as Reed-Solomon frames.

12. A method as claimed in claim 10, wherein said transmitting step comprises the step of:
grouping respective pluralities of said data frames into respective groups of data frames.

13. A method as claimed in claim 10, wherein said transmitting step comprises the step of:
assigning numbers to said data frames.

14. A method as claimed in claim 13, wherein:
said establishing step establishes said timing reference based on said numbers assigned to said data frames.

15. A method as claimed in claim 13, wherein said transmitting step comprises the step of:
including in said data frame stream at least one frame numbering data packet on which numbering of said data frames is based.

16. A method as claimed in claim 9, wherein said establishing step includes the step of:
determining, based on said timing reference, time instants at which data frames transmitted from said user terminal are to arrive at said network hub.

17. A method as claimed in claim 9, further comprising the step of:
controlling said user terminal to transmit data to said network hub in accordance with said timing reference.

18. An apparatus, adapted for use with a satellite-based communications network comprising at least one satellite, at least one network hub and a plurality of user terminals, for providing a timing reference on which data transmissions between said at least one network hub and said plurality of user terminals are based, said apparatus comprising:
a transmitter, adapted to transmit an uplink signal to a satellite in said network for receipt by said at least one network hub, said plurality of user terminals and said apparatus;
a receiver, adapted to receive an echo signal based on said uplink signal transmitted to said satellite; and
a timing device, adapted to establish said timing reference based on a time at which said receiver receives said echo signal in relation to a time at which said transmitter transmitted said uplink signal.

19. An apparatus as claimed in claim 18, wherein:
said timing device is adapted to generate a stream of data frames as said timing reference.

20. An apparatus as claimed in claim 19, wherein:
said timing device generates said stream of data frames as Reed-Solomon frames.

21. A method, for use with a satellite-based communications network comprising at least one satellite, at least one network hub and a plurality of user terminals, for providing a timing reference on which data transmissions between said at least one network hub and said plurality of user terminals are based, said method comprising the steps of:
transmitting, from an apparatus other than said network hub, an uplink signal to a satellite in said network for receipt by said at least one network hub, said plurality of user terminals and said apparatus;
receiving at said apparatus an echo signal based on said uplink signal transmitted to said satellite; and
establishing said timing reference based on a time at which said apparatus receives said echo signal in relation to a time at which said apparatus transmitted said uplink signal.

22. A method as claimed in claim 21, wherein said establishing step includes the step of:
generating a stream of data frames as said timing reference.

23. A method as claimed in claim 21, wherein said establishing step includes the step of:
generating a stream of Reed-Solomon frames as said timing reference.
